(19) United States
(12) Patent Application Publication
(10) Pub. No.: US 2006/0146522 A1
(43) Pub. Date: Jul. 6, 2006

(54) Portable radio with reading light

(76) Inventor: Kenneth Lee, New Territories (HK)

Correspondence Address: ALIX YALE & RISTAS LLP, 750 MAIN STREET, SUITE 1400, HARTFORD, CT, 06103, US

(21) Appl. No.: 11/029,151

(22) Filed: Jan. 4, 2005

(51) Int. Cl. F21V 19/02

(52) U.S. Cl. 362/171; 362/188; 362/199; 362/285

(57) ABSTRACT

A portable sound reproducing device such as a portable radio includes a body housing electronics to reproduce sound signals, a control panel for manipulating the electronics, and an elongate light-emitting bar having a pair of legs extending from opposite ends and pivotally attached to the body at either side of the control panel.

### BACKGROUND OF THE INVENTION

The present invention relates to portable sound-making devices that reproduce sounds from removable media discs or the like, or reproduce sound signals transmitted from remote locations. More particularly, although not exclusively, the invention relates to a portable radio having an extendable light that might be used for reading whilst listening to the radio.

Known portable radios include a receiver for receiving remote signal and a speaker for reproducing the signals for listening purposes. Sometimes it might be desirable to listen to the radio at night time whilst reading. Ordinarily in such circumstances, one would have to provide a separate reading light or flashlight.

### OBJECTS OF THE INVENTION

It is an object of the present invention to overcome or substantially ameliorate the above disadvantage and/or more generally to provide an improved portable sound reproducing device with a light.

### DISCLOSURE OF THE INVENTION

There is disclosed herein a portable sound reproducing device, comprising:

a body housing electronics to reproduce sound signals,

a control panel for manipulating the electronics, and

an elongate light-emitting bar having a pair of legs extending from opposite ends thereof and pivotally attached to the body at either side of the control panel.

Preferably, the device further comprises a fluorescent tube located within the light-emitting bar, and the body also houses a battery for powering the electronics and the fluorescent tube, and electrical conductors extend through at least one of the legs to deliver current from the battery to the fluorescent tube.

Alternatively, the device further comprising an array of LEDs located within the light-emitting bar, and wherein the body also houses a battery for powering the electronics and the LEDs, and wherein electrical conductors extend through at least one of the legs to deliver current from the battery to the LEDs.

Preferably, the body comprises a recess into which the light-emitting bar and legs are at least partially received in a storage configuration thereof.

Preferably, the device further comprises a generator housed within the body for recharging the battery, and an external crank handle is attached to the generator.

Preferably, the crank handle is configured to pivot into a storage position in which it is at least partially located within a crank handle recess formed on the body.

Preferably, the device further comprises a carry handle attached pivotally to the body.

Preferably, the device further comprises a carry handle recess into which the carry handle is at least partially received in a storage configuration thereof.

Preferably, the device further comprises a loudspeaker housed within the body and covered by a grille that is flanked by portions of the recess.

### BRIEF DESCRIPTION OF THE DRAWINGS

A preferred form of the present invention will now be described by way of example with reference to the accompanying drawings, wherein:

FIG. 1 is a schematic front elevation of a portable radio with its carry handle, light-emitting bar and recharging crank extended,

FIG. 2 is a schematic front elevation of the portable radio with its carry handle, light-emitting bar and recharging crank retracted,

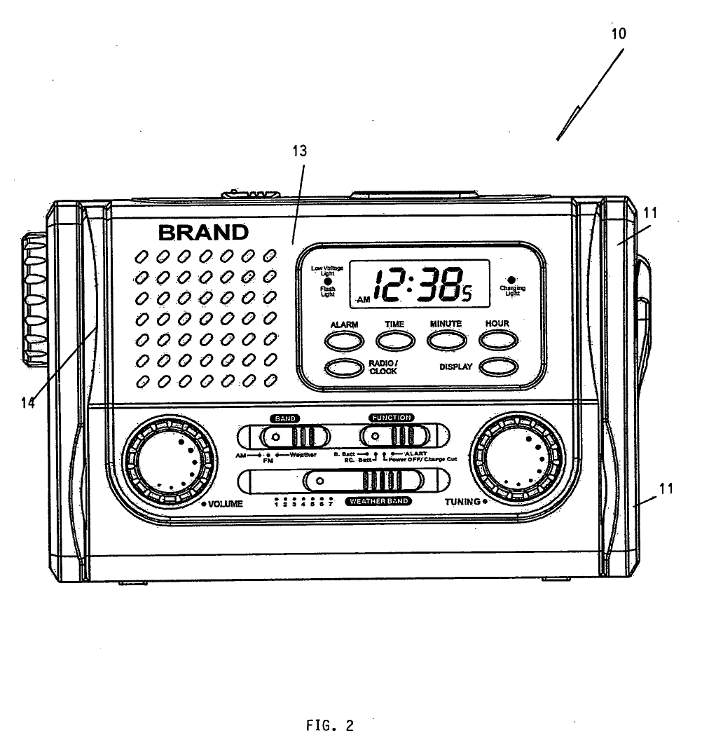

FIG. 3 is a schematic back elevation of the portable radio in the configuration of FIG. 2, and

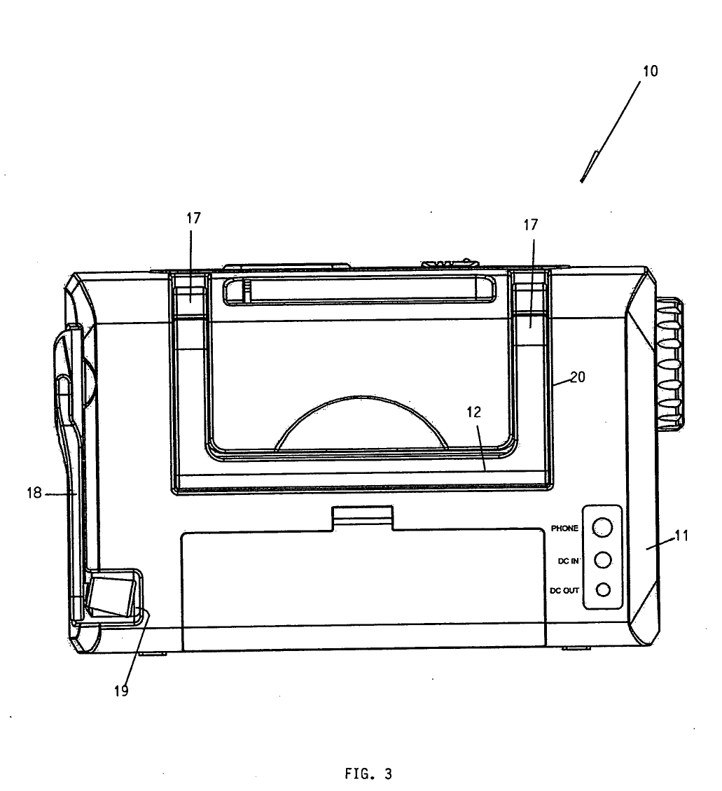

FIG. 4 is a schematic end elevation of the portable radio in the configuration of FIG. 1.

### DESCRIPTION OF THE PREFERRED EMBODIMENT

In the accompanying drawings there is depicted schematically a portable radio 10 comprising a body 11 that would typically be formed of moulded plastics material. A carry handle 12 is attached pivotally at 17 to the body 11 and can be at least partially received within a U-shaped carry handle recess 20 when pivotally retracted for storage purposes.

Also attached pivotally to the body 11 is a light-emitting bar 13 within which there extends a longitudinal fluorescent tube or an array of high-efficiency LEDs. At each end of the light-emitting bar 13, there is a leg 14 attached pivotally at 15 to the body 11. These pivot connections might include a series of detents so that the light-emitting bar can click into a number of preselected, self-maintaining orientations, or might alternatively be provided with tight pivot bearings so that any selected orientation of the light-emitting bar is self-maintaining.

Electrical conductors would extend internally of one or both of the legs 14 for providing power from a battery (not shown) that is located within the body 11 to the fluorescent tube. A light switch 23 is provided for this purpose.

At the front of the body 11, there is provided a control panel 13 and a speaker grille 21. There is also a display panel 22 that might display the time and/or tuned radio frequency for example.

There is a crank handle 18 extending from one end of the body 11 which can be retracted pivotally to be at least partially received within a crank handle recess 19. The crank handle turns a shaft of an internal generator (not shown). Turning of the crank handle about the shaft axis would rotate the generator to recharge the internal battery. The battery would power the radio as well as the fluorescent tube.

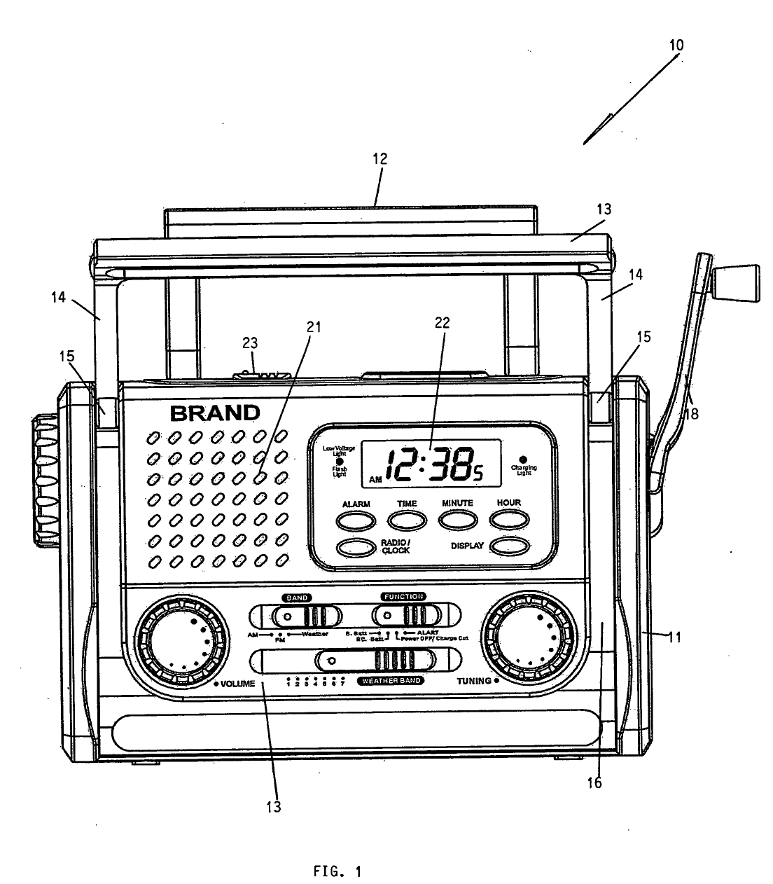

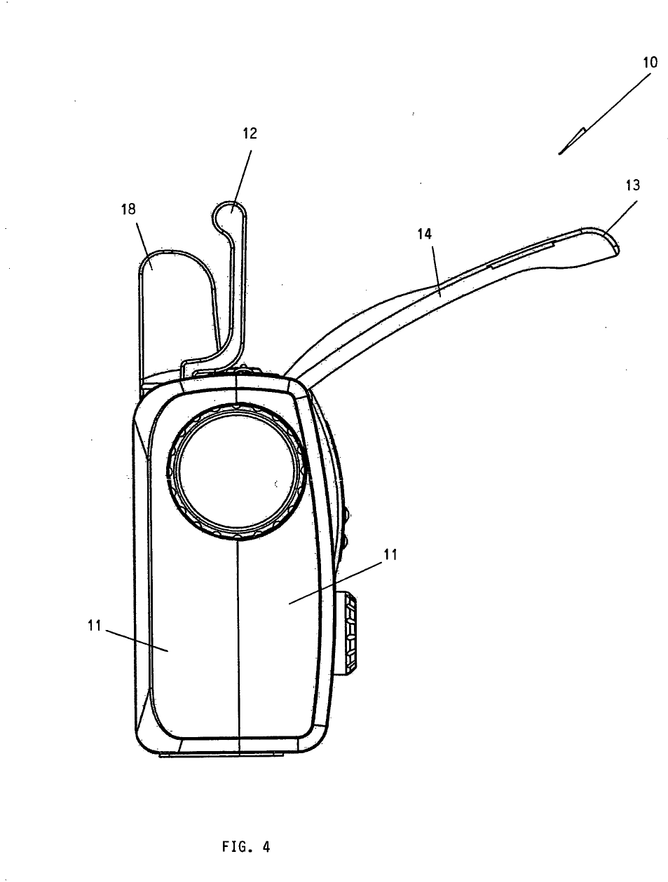

In use, one can use the radio by manipulating the control panel 13. The light-emitting bar 13 can be raised from its retracted storage configuration into the configurations depicted in FIGS. 1 and 4 and the switch 23 activated to energise the fluorescent tube. As an alternative to the switch, there may be a switch associated with the pivots 15 to automatically energise the fluorescent tube upon lifting the light-emitting bar 13 from its storage position.

It should be appreciated that modifications and alterations obvious to those skilled in the art are not to be considered as beyond the scope of the present invention. For example, instead or in addition to functioning as a radio, the device might include a CD, MiniDisc™ or other media player.

1. A portable sound reproducing device, comprising:
a body housing electronics to reproduce sound signals,
a control panel for manipulating the electronics, and
an elongate light-emitting bar having a pair of legs extending from opposite ends thereof and pivotally attached to the body at either side of the control panel.

2. The device of claim 1, further comprising a fluorescent tube located within the light-emitting bar, and wherein the body also houses a battery for powering the electronics and the fluorescent tube, and wherein electrical conductors extend through at least one of the legs to deliver current from the battery to the fluorescent tube.

3. The device of claim 1, further comprising an array of LEDs located within the light-emitting bar, and wherein the body also houses a battery for powering the electronics and the LEDs, and wherein electrical conductors extend through at least one of the legs to deliver current from the battery to the LEDs.

4. The device of claim 1, wherein the body comprises a recess into which the light-emitting bar and legs are at least partially received in a storage configuration thereof.

5. The device of claim 2, further comprising a generator housed within the body for recharging the battery, and an external crank handle is attached to the generator.

6. The device of claim 5, wherein the crank handle is configured to pivot into a storage position in which it is at least partially located within a crank handle recess formed on the body.

7. The device of claim 1, further comprising a carry handle attached pivotally to the body.

8. The device of claim 7, further comprising a carry handle recess into which the carry handle is at least partially received in a storage configuration thereof.

9. The device of claim 4, further comprising a loudspeaker housed within the body and covered by a grille that is flanked by portions of the recess.

10. The device of claim 3, further comprising a generator housed within the body for recharging the battery, and an external crank handle is attached to the generator.
